(19) United States
(12) Patent Application Publication
(10) Pub. No.: US 2016/0186018 A1
(43) Pub. Date: Jun. 30, 2016

(54) Adhesive, method of producing the same and uses thereof

(71) Applicant: Hannu Mikkonen, Espoo (FI)

(72) Inventor: Hannu Mikkonen, Espoo (FI)

(73) Assignee: TEKNOLOGIAN TUTKIMUSKESKUS VTT, Espoo (FI)

(21) Appl. No.: 13/516,336

(22) PCT Filed: Dec. 16, 2010
(86) PCT No.: PCT/FI2010/051049

§ 371 Date: Jun. 24, 2013

(30) Foreign Application Priority Data
Dec. 16, 2009 (FI) 20096339

(51) Int. Cl. C09J 103/10

(52) U.S. Cl. CPC C09J 103/10

(57) ABSTRACT

An adhesive composition and a method of producing the same. According to the present invention, a first adhesive component which comprises polyphenol and another adhesive component which comprises a starch derivative, are dissolved or dispersed in water. The polyphenol and the starch derivative are added into the water at a weight ratio which is approximately 1:50 . . . 50:1, in which case the quantities of polyphenol and starch derivative added are such that the dry matter percentage of the adhesive composition is at least 40% by weight. The composition according to the present invention is particularly suitable for gluing of fibrous, such as laminated or veneer-based products.

The present invention relates to an adhesive which comprises a polyphenol based adhesive component, according to the preamble of claim 1.

The present invention also relates to a method of producing the adhesive according to the preamble of claim 13 and use according to claim 14.

Interest in natural construction is increasing both in Finland and in Central Europe. Progress is limited by supply of suitable products. Concerning wood-based boards there is no supply of even one natural product because suitable binders are absent. Board products have a significant role in building systems and building solutions and thus the market potential of board-like products is large.

Polyphenol adhesives are already known and they have been used for gluing wood composites, such as chipboards, plywood and fibre boards, ever since the 1970s. The adhesive component of a conventional polyphenol adhesive is a phenolic compound—which is separated from natural products such as tannin or lignine or lignosulphonate or a similar compound which comprises a phenol unit which is possibly part of a repeating unit of polyphenol (gallate, cinnamic acid, flavone). Besides phenol, the basic units of polyphenols can comprise for example pyrocatechol, pyrogallol, resorcinol, phloroglucinol and hydrochinone.

Adhesives which are based on natural tannins behave like thermoplastics. Generally, formaldehyde is used as their crosslinker/crossbridger.

Advantages of tannin and corresponding polyphenols, such as lignine and lignosulphonate are their good moisture and water resistance properties. However, tannins are fairly expensive because of long transport distances and they are not very easily available. Furthermore, in traditional techniques, excessively large amounts of formaldehyde must be used to generate the crosslinks.

Another disadvantage of tannin adhesives is their high viscosity, which makes it difficult to increase their solids percentage, without aggravating the application.

The present invention is associated with natural adhesives, which are produced by using raw materials, namely polyphenols, which are sourced from renewable natural resources. The present invention is based on the principle that at least part of the polyphenol in a traditional polyphenol-based adhesive is replaced with a derivative of starch and a similar polysaccharide, in order to increase the solids percentage. More preferably, the derivative in question is a product generated from starch by transglycosylation.

According to the present invention, a first adhesive component which comprises polyphenol, and a second adhesive component which comprises a starch derivative, are dissolved or dispersed in water. The weight ratio of the polyphenol and the starch derivative which are added into the water is approximately 1:50 . . . 50:1, in which case the added quantities of the polyphenol and the starch derivative are such that the dry matter percentage of the adhesive composition is at least 40% by weight.

Unexpectedly, it has now been found that it is possible to replace a significant part of the polyphenol in traditional polyphenol adhesives with a starch derivative, without the adhesion properties of the adhesive suffering. However, at the same time, it is possible to considerably increase the solids percentage.

More specifically, the adhesive according to the present invention is mainly characterized by what is stated in the preamble of claim 1.

Considerable advantages can be achieved with the present invention. Thus, as the results below demonstrate, by using combinations of polyphenols and starch and similar natural products, it is possible to produce with simple and affordable processes products, which generate adhesive for the production of chipboard and carpentry products. For instance, by suitably modifying starch and even by decreasing the level of its molecular weight, an adhesive formulation which has a high dry matter level and a low viscosity level is achieved. By using these components in polyphenol-based adhesives, compositions which have excellent moisture and water resistance properties in combination with a high solids percentage and a suitably low viscosity are generated, in which case it is easy to apply the compositions onto the surfaces to be glued, for instance by spraying.

On the basis of the results, it is possible to replace approximately half or more of the polyphenol components of traditional tannin-based or similar polyphenol-based adhesive with starch adhesive, without impairing the strength properties.

Test results show that, with the present compositions, particularly those boards which are made by using dispersion adhesive compositions are able to withstand well soaking in water, due to the hydrophobic starch derivatives comprised in them. Water absorption tests and thickness swelling tests demonstrate that the new adhesive compositions have natural moisture resistance ability. The reactivity of adhesives is good per se and it can still be improved by activating the wood particles or other surface to be glued. Test results demonstrate that chips and veneer surfaces to be glued are reactive and that it is possible to attach to them, in suitable conditions, compounds such as polyphenols, for example tannin, by using phenoloxidase enzymes, such as laccase.

On the other hand, by adding polyphenols, such as tannin, to starch derivative based compounds, for instance approximately 10-50% of the starch derivative amount (based on the weight), an adhesive is generated which has a good viscosity and excellent gluing properties.

The adhesives are suitable for use in production of wallboards, such as chipboards. Generally, it is possible to replace commercial adhesives (phenol formaldehyde, urea formaldehyde) which are used in the production of chipboards, with starch-lignine-based or tannin-based organic adhesives. The transverse tensile strengths and the thickness swellings are at a good level. The use of starch clearly lowers the price of the adhesive, the mechanical results still being at a good level.

Wood veneers, too, have been successfully glued with the adhesives. In these tests, the breaking loads achieved have been of the same magnitude as for commercial adhesives and, furthermore, in individual cases, 100% wood failure results have been achieved. Chemically crosslinked adhesives have functioned best. In addition, by treating wood veneers with enzymes, good gluing results have been achieved with the starch adhesives used. It is possible to improve the properties of the boards by pretreating the chips for instance with enzymes before gluing with starch adhesives.

In the following, the present invention will be examined more closely with the aid of a detailed description and the accompanying drawings. In the drawings,

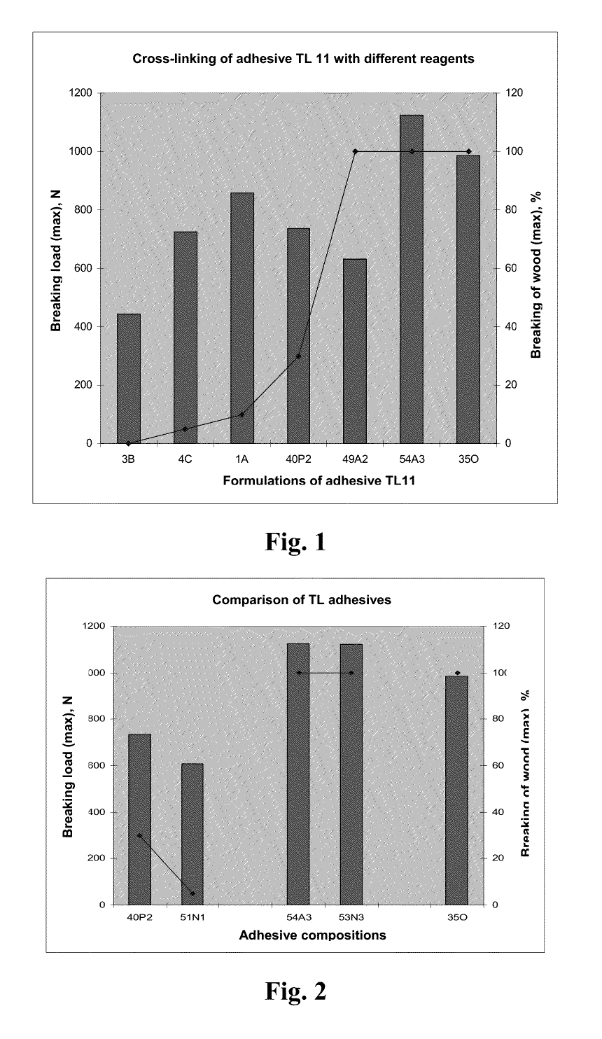

FIG. 1 shows the gluing results of crosslinked tannin-bearing starch adhesives;

FIG. 2 shows how the adhesive composition affects the gluing properties;

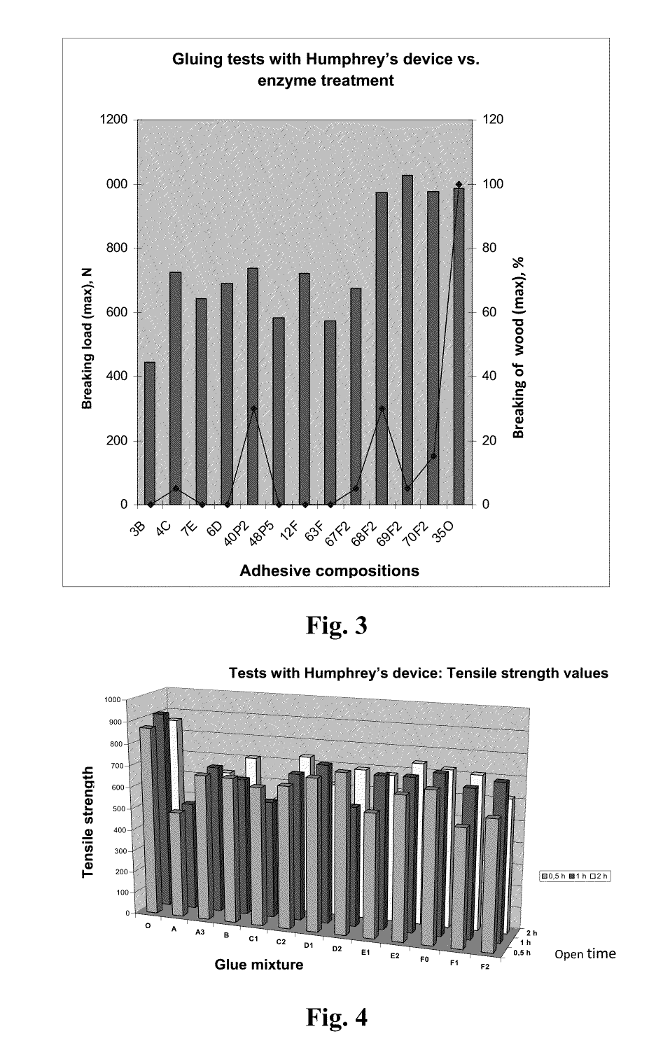

FIG. 3 shows how enzyme treatments affect the gluing results of tannin-bearing starch adhesives;

FIG. 4 shows the results of the gluing tests, in which the basic composition of the starch adhesive varied;

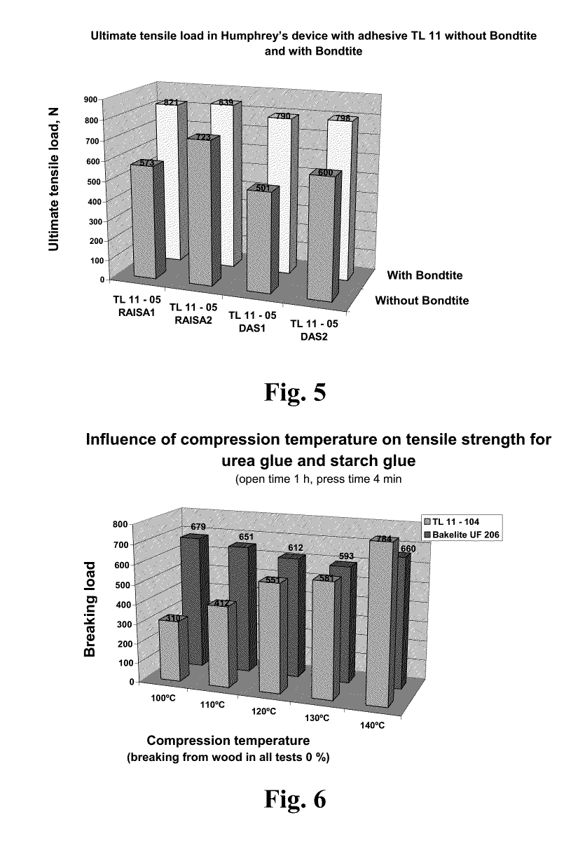

FIG. 5 shows the results of the gluing tests, in the form of bar charts;

FIG. 6 shows how the compression temperature affects the gluing result;

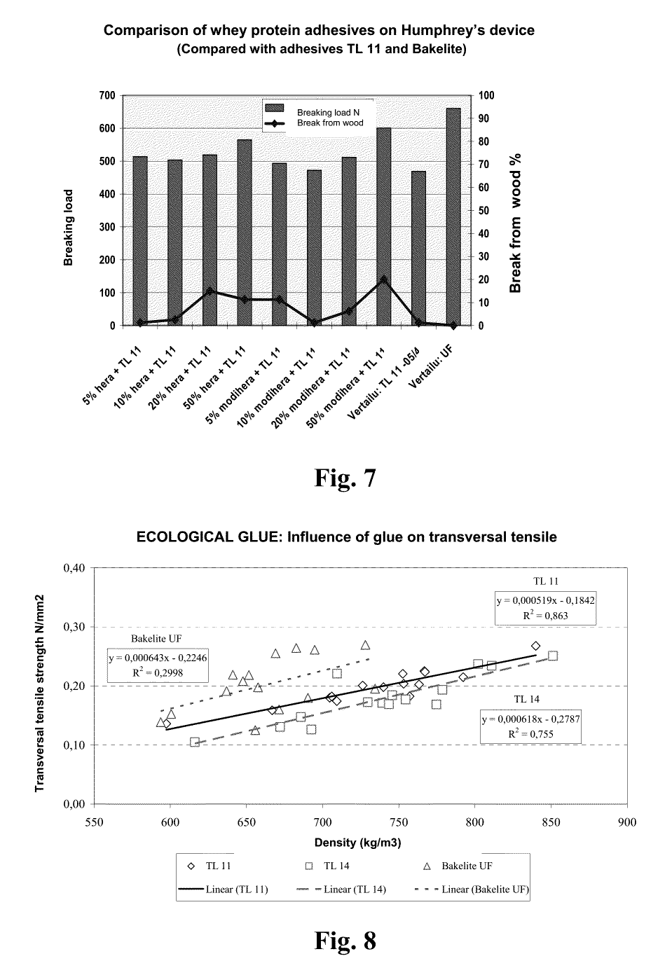

FIG. 7 shows the gluing results of whey protein adhesives;

FIG. 8, in turn, shows how the adhesive affects the transverse tensile strength, when using starch adhesives TL 11 and TL 14, and commercial UF adhesive;

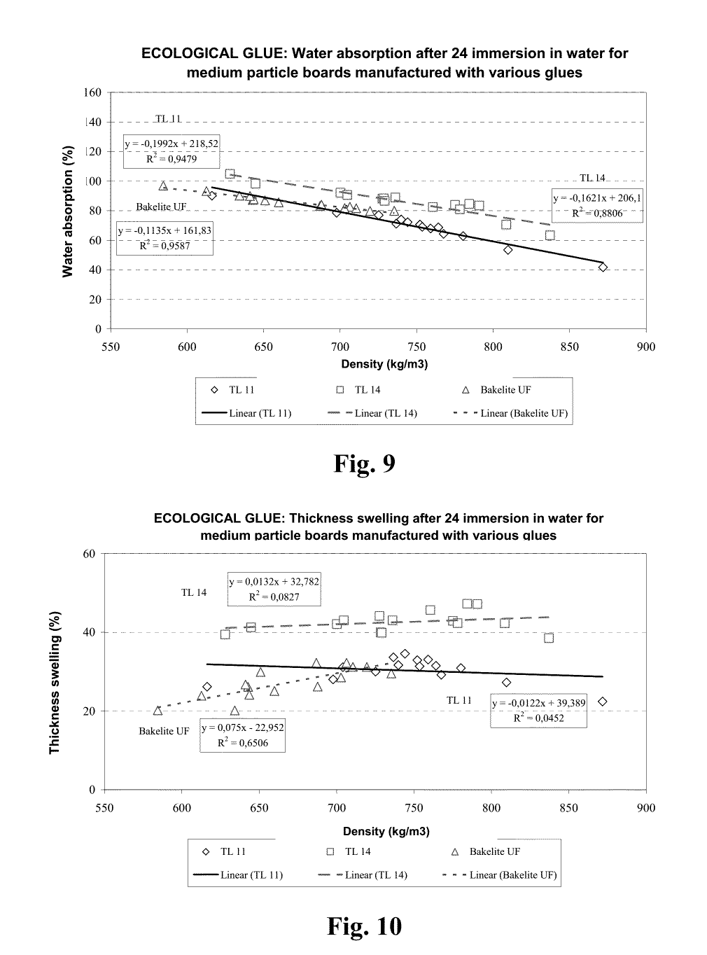

FIG. 9 shows how the adhesive affects the water absorption during a 24-hour water soaking, when using starch adhesives TL 11 and TL 14, and commercial UF adhesive,

FIG. 10 shows how the adhesive affects the thickness swelling during a 24-hour water soaking, when using starch adhesives TL 11 and TL 14, and Bakelite UF;

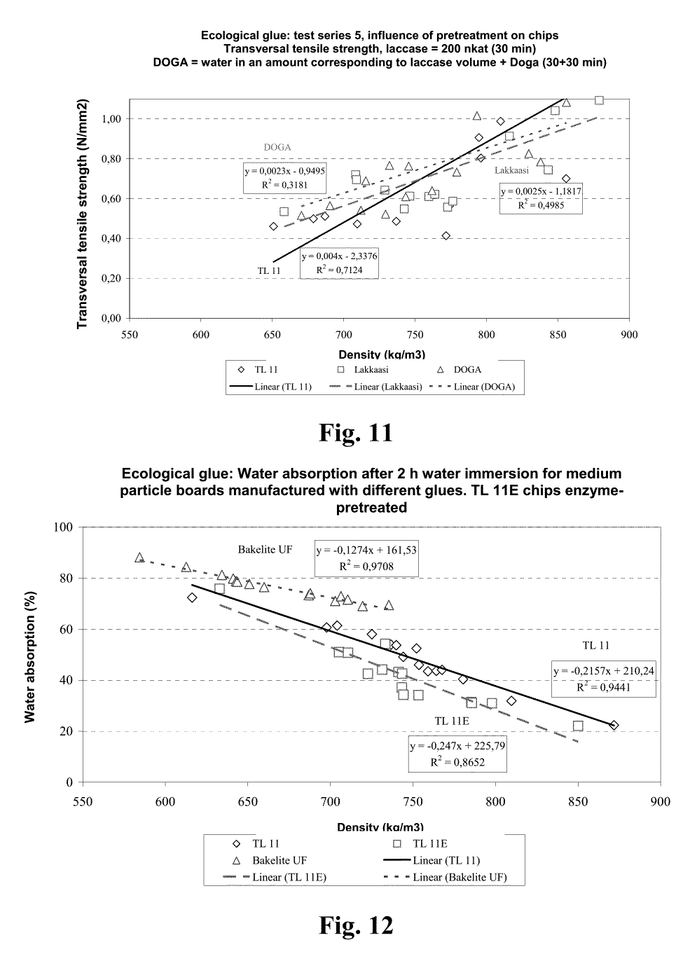

FIG. 11 shows how pretreatment of chips affects the transverse tensile strength. Laccase=200 nkat/g (30 min); DOGA=amount of water corresponds to laccase volume+Doga (30+30 min);

FIG. 12 shows how pretreatment of chips affects the water absorption in chipboards during a 2-hour intermediate soaking; TL11E=laccase 200 nkat/g+DOGA (30+30 min);

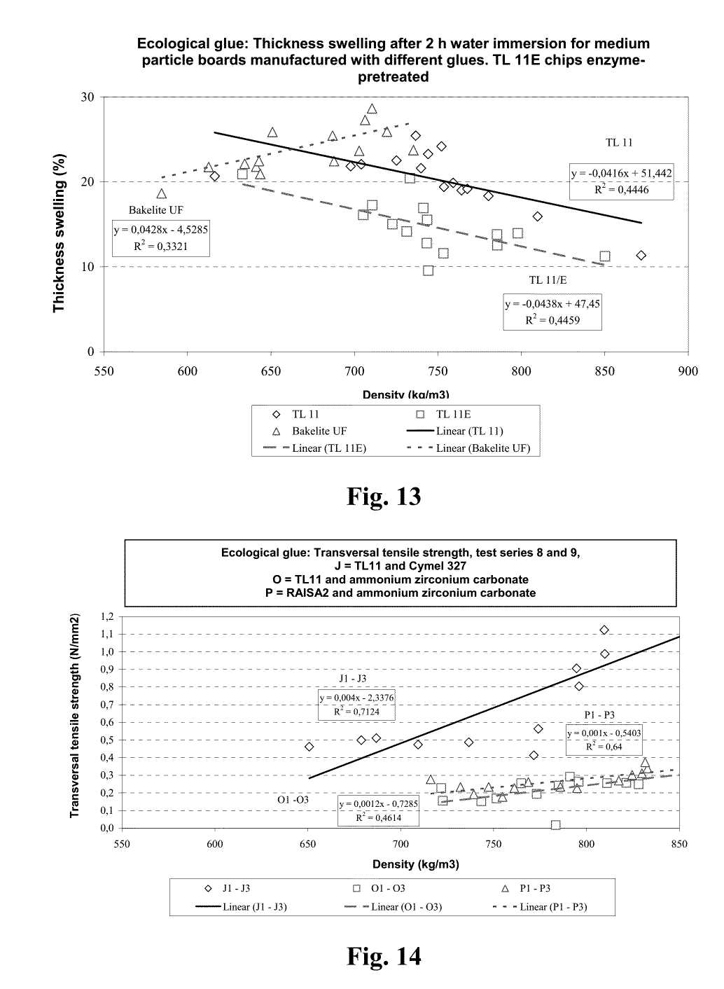

FIG. 13 shows how pretreatment of chips affects the thickness swelling during a 2-hour water soaking; TL11E=laccase 200 nkat/g+DOGA (30+30 min);

FIG. 14 shows the strength results when different crosslinkers are used; and

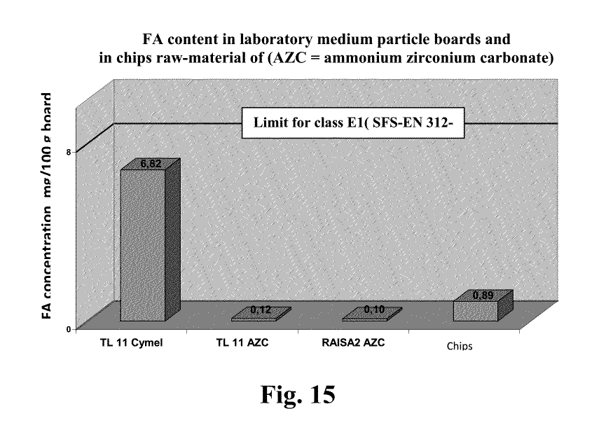

FIG. 15 shows percentages of formaldehyde which are released from the boards.

In the present invention, a significant part of the tannin in a typical tannin adhesive is replaced with a starch derivative, particularly with a transglycosylation product of starch.

According to a preferred embodiment, the proportion of polyphenol is smaller than of the starch derivative. Most suitably, the proportion of tannin or a similar polyphenol in the transglycosylation product is approximately 5-75 parts by weight, in particular approximately 10-50 parts by weight of polyphenol per 100 parts by weight of starch derivative. At least one, preferably both or all adhesives are dispersible in water or preferably miscible in water and dissolvable in water even at room temperature.

According to another embodiment, it comprises further, as adhesive component, also 0.1-50 parts by weight, in particular approximately 0.5-40 parts by weight and most suitably 1-20 parts by weight of protein per 100 parts by weight of starch derivative.

The first component of the adhesive of the present invention is polyphenol and the other component a starch-based transglycosylation product. The first component is a natural product, which typically can be separated from annual and perennial plants, particularly from aborescent plants.

Examples of polyphenols are tannin, lignine and flavonoid and mixtures thereof, and derivatives of these compounds or mixtures thereof. The tannins can be so called polymeric tannins, which are built up of flavonoids and phenolic acids. Generally, they are divided into condensable and hydrolysable tannins Examples of the latter ones are gallotannins and ellagitannins. Condensed tannins are typically oligomeric compounds and they are also called proanthocyanidines. Typically, lignines comprise a phenolic structural element, which is for example coniferyl, sinapyl or paracoumaryl alcohol. Examples of flavonoids are antocyanides (such as cyanidin and malvadin), flavonols (such as quercetin and myricetin) and catechins (such as epicatechin and gallocatechin).

Examples of derivatives of tannin, lignine and flavonoids are their salts, ethers, esters and other derivatives (for example lignosulphonates).

It is possible to separate phenolic compounds from plants in ways which are known per se. Typically, the separation is based on extraction, in which case mere water, the pH of which is especially adjusted to be acidic, is used. It is also possible to use a mixture of water and an organic solvent, and an organic solvent. After extraction, the extract which comprises phenolic compounds is further cleaned typically by using liquid-liquid extraction or, correspondingly, the phenolic compounds are separated from the extract by using adsorption separation which, due to its selectivity, is a more common method than the liquid-liquid extraction. Generally, by using the method described above, it is possible to concentrate the phenolic compounds to a percentage of approximately 1-20% (calculated from the total weight). Furthermore, it is still possible to increase the percentage of phenolic compounds by using adsorption chromatography.

As described above, it is possible for instance to separate the tannins from wood and leaves by extraction and using for example lyophilic solvents, such as lower alcohols, for example isopropanol or acetone. Usually, the tannin is generated as a 10-30% by weight viscose solution, which can be diluted and cleaned by using an ion exchanger.

Flavoinoids can be separated with corresponding methods.

Besides using methods which are described above, it is possible to recover lignine more preferably by separation from cooking liquor used in wood defibering or wood cooking.

The starch derivative is produced from “native starch”. This means the same as “natural starch”, i.e. starch which is available from the plant world, for instance from tuber vegetables or grain crops. The starch can be based on any natural starch, the amylose percentage of which is 0-100% and amylopectin percentage 100-0%. Accordingly, the starch can be sourced from barley, potato, wheat, oats, pea, corn, tapioca, sago, rice or similar tuber vegetables or grain crops.

The transglycosylation products are produced from the starch mentioned above, by bringing the starch to reaction under acidic conditions with such an alcanol which comprises 1-6 hydroxyl groups, and by recovering the reaction product. Most suitably, methanol, buthanol, ethylene glycol, propylene glycol, butanediol, trimethylolpropane and/or glycerol are used. These react with ether bonds which are between the anhydroglucose units, in which case glycoside is generated, in which an alkyl group or hydroxyalkyl group is attached via an ether bond to a terminal anhydroglucose unit of the starch chain. By using polyvalent alcanol, it is possible to generate a situation where an anhydroglucose group is attached to each one of two or more hydroxyl groups of the alcanol.

In the production reaction, the starch is generally mixed with monool, diol or triol in order to form the reaction mixture, the reaction mixture is then heated to a temperature below the boiling temperature of the alcanol, and the reaction with monool, diol or triol is continued until a bright melt is generated. After that, the reaction mixture is cooled and the reaction product is precipitated, washed and dried. Then, the reaction product is precipitated for instance in alcohol. It is also possible to prepare the product in one phase in such a way that a reaction product is not separated from the reaction mixture, instead the solution phase is removed by evaporation.

A typical reaction mixture is 100 parts by weight of starch and 1-200 parts by weight of alcanol (polyol) depending on the number of hydroxyl groups comprised in the alcanol/polyol molecules and a catalytic amount of an acidic catalyst. The catalysts used are acids, such as sulphuric acid, p-toluenesulphonic acid, univalent, divalent and trivalent phosphoric acids, or acidic salts, such as sodium hydrogen sulphate. Because the starch component, particularly in a transglycosylated form is dissolved into alcanol/polyol, it is possible to use a heterogeneous catalyst, too, such as an acidic ion-exchange resin. When the basic materials are glycerol and native starch, for example potato starch, a mixture is generated which comprises glycerol 1-, glycerol 2-, glycerol 1,2-, glycerol 1,3- and glycerol 1,2,3-O-1-glucopyranoside ethers. This material can comprise 1-20% of (unreacted) glycerol.

As a result of the transglycosylation reaction, the chain which comprises anhydroglucose units of starch is degraded, but according to the present invention, it is not necessary to take the reaction as far as to the monomeric stage. On the contrary, it has been found advantageous to leave the molecular weight of the transglycosylation product at the oligomer/polymer level, in this case at a degree of polymerization of DP 7 or higher (even level DP 300). A product which is generated in such a way has the beneficial properties of transglycosylation products (plasticising effect, good self-adhesiveness), and it gives a strong enough adhesion. Furthermore, being a relatively small molecule, it is capable of increasing the dry matter without affecting the viscosity. The molecular weight of the transglycosylation product is generally 1,200-50,000, preferably 1,300-10,000 and more preferably 1,300-5,000. This relates particularly to the transglycosylation product of native starch.

In order to generate the tg-component of the adhesive, the transglycosylation products are mixed with a plasticising material. The amount of the plasticiser is most suitably 0.01-95% by weight, preferably approximately 1-50% by weight of the composition. Any monomeric or polymeric plasticisers are suitable for use, such as, for example, monoacetin, glycerol, triethyl citrate and also oligoesters of succinic acid and polyol, such as diethylene glycol succinate. In the adhesive compositions according to the present invention, it is possible to use different polyfunctional compounds: dialdehydes, such as glyoxal or glutaraldehyde; diepoxydes, such as ethylene glycol diglycidyl ether; urea; urea derivatives, such as hydroxymethyl urea, or multifunctional carboxylic acids, such as citric acid.

Generally, the dry matter percentage of adhesive is approximately 10-100% by weight, whereas, in practice, the dry matter percentage of the adhesive according to the present invention is clearly higher than the lower limit, in particular 40% or more.

Herein, “dry matter percentage” means the remaining material quantity of the adhesive composition, after the water has been evaporated from the adhesive composition. Comprised in the dry matter are the adhesive or adhesive mixture which forms the actual binder, its possible plasticiser, and auxiliary substances and additives of the solution, such as crosslinking materials, surface active materials, waxes, etc.

When the polyphenol and the starch component are mixed together, an adhesive, i.e. adhesive composition is achieved, the viscosity of which is technically at a usable level and, at the same time, the dry matter percentage is so good (approximately 40% by weight or more) that the adhesive does not comprise excess solvent, such as water.

Typically, the viscosity of an adhesive composition which is suitable for use, is approximately 1,000-50,000 cP at a temperature of 120° C., in particular approximately 2,500-30,000 cP at 120° C. and most suitably approximately 3,000-15,000 cP at 120° C.

According to a preferable embodiment of the present invention, technically successful gluing requires that the viscosity of the adhesive formulation at a dry matter percentage of, for example, 45-65% is, for example, 500-3,500 mPas at a temperature of 18-25° C. In this case, it is possible to apply the adhesive wet at 15-45 g/m², which corresponds to 7-30 g/m² of dry adhesive.

Furthermore, it is possible to add different additives and regulatory materials to the adhesive compositions. Generally, the percentage of the additives and the auxiliary substances is 0.01-30% by weight of the adhesive composition.

Generally, the additives comprised in an adhesive composition are inorganic chemicals, polyfunctional compounds, dialdehydes, diepoxydes, urea, urea derivatives or multifunctional carboxylic acids and, as additives or regulatory materials, water soluble ethylene glycol esters, ethylene glycol ethers, glycerol esters, monoacetin, CMC or other water soluble cellulose derivatives, such as water soluble methyl or ethyl cellulose, or water soluble hydroxyl propyl starch or oxidised starch and/or proteins. The proteins can be sourced from the plant world or the animal world.

The composition can also comprise a crosslinker, such as an aldehyde compound, dialdehyde compound, melamine resin or inorganic salt or a mixture of two or more crosslinkers.

Adhesives according to the present invention are used for gluing of fibre based products, such as laminated or veneer based products. Examples of these are plywood products, which are produced from hardwood or softwood, chipboards, fibre boards, composite boards, laminated veneer lumber (LVL), and similar glued wood products. In principle, the adhesives can also be used for gluing sheet or web material, such as paper and cardboard.

The adhesive can be applied with any known coating technique, such as blade coating, roll coating, rod coating or spray coating. The viscosity of the adhesive can be adjusted to fit the application method.

Typically, the application temperature is 20-300° C., in particular approximately 20-250° C.

If desired, it is possible to pretreat the wood material before gluing. Thus, wood chips can be treated before gluing with oxidising materials, such as an oxidising enzyme or chemical, and/or substrates of oxidising enzymes, such as with gallates (see example 11). It is also possible to apply a physical treatment to the wood material, for instance heat treatment.

The following examples illustrate the present invention.

### EXAMPLE 1

### Production of Starch Adhesive

### Adhesives which Comprise Hydroxypropyl Starch

The starch adhesives were produced by using different mixture ratios of the transglycosylation products of starch and the hydroxypropyl starches which have different degrees of substitution and different starch raw materials. The hydroxypropyl starches were produced by using a method according to patent FI 107930 and the transglycosylation reactions of the starch were carried out according to patent FI 113876.

The following table (table 1) shows the compositions and the viscosities of the adhesives.

TABLE 1
Basic compositions and viscosities of starch
adhesives which comprise hydroxypropyl starch

| Adhesive | | Hydroxypropyl | Viscosity, 25° C. |
|---|---|---|---|
| code | Starch polyol | starch | cP/Cap % |
| TL-11 | 90 | 10 | 635/60.0 |
| | | (LM 100) | |
| TL-12 | 100 | — | 720/81 |
| TL-13 | 42 | 58 | 2950/50.1 |
| | | (DL 20) | |
| TL-14 | 95 | 5 | 200/51.9 |
| | | (LN 100) | |
| TGGL-11 | 85 | 15 | 200/61 |
| | | (DL 20) | |
| TGGL-12 | 70 | 30 | 408/61.2 |
| | | (DL 20) | |
| TGGL-13 | 70 | 30 | 790/60.3 |
| | | (DL 20) | |
| TL-3/2 | 77 | 23 | 8000/61.9 |
| | | (DL 20) | |

Table markings:
“LM 100” is hydroxypropyl starch, which has a molar degree of substitution of 0.4, and which is produced from amylose-rich corn starch
“LN100” is hydroxypropyl starch, which has a molar degree of substitution of 0.4, and which is produced from potato starch
“DL 20” is hydroxypropyl starch, which has a molar degree of substitution of 1.2, and which is produced from hydrolysed barley starch
In adhesives marked with “TL”, the reagent used in the transglycosylation is glycerol, and in adhesives marked with “TGGL”, the reagent used in the transglycosylation is a mixture of glycerol and ethylene glycol.

The production conditions of starch polyols are described in more detail in table 5.

The starch adhesives were used as the main components when adhesive mixtures for gluing of chipboards and wood veneers were produced.

### EXAMPLE 2

### Production of Starch Adhesive

### Adhesives which Comprise Oxidised Starches

Dialdehyde starches (DAS) were produced from potato starch with periodate oxidation by using the aqueous slurry method, varying the amount of the reagent and the reaction time. Commercial oxidised starches (Ciba Specialty Chemicals, RAISA) were used as reference substances. The properties of oxidised starches are shown in table 2.

TABLE 2
Properties of oxidised starches

| | | | Raisamyl | Raisamyl |
|---|---|---|---|---|
| | DAS 1 | DAS 2 | 01211 | 0.4221 |
| Mw, g/mol | 192 400 | 9 900 | 760 000 D | 12 000 000 |
| Mn, g/mol | 1 400 | 1 550 | 62 000 D | |
| Polydispersity | 139 | 6.4 | 12.3 | |
| Mw/Mn | | | | |
| Carboxylic groups | 0.38% | 0.34% | 0.26% | |

D Daltons

The corresponding adhesive formulations were produced from oxidised starches in a similar manner as from the hydroxypropyl starches, by replacing the hydroxypropyl starch with oxidised starch. Table 3 shows the produced adhesives and their viscosities.

TABLE 3
Adhesive formulations produced from oxidised starches

| | Oxidised starch %/ | Starch | Viscosity |
|---|---|---|---|
| Code | Quality | polyol % | cP/Cap % |
| TL11-05 Raisa 1 | 10/Raisamyl 01211 | 90/7TGG14 | 3650/62 |
| TL11-05 Raisa 2 | 10/Raisamyl 0.4221 | 90/7TGG13 | 3533/55 |
| TL11-05 Raisa 2.1 | 10/Raisamyl 0.4221 | 90/7TGG13 | 9100/64 |
| TL11-05 DAS 1 | 5/DAS 1005 | 95/7TGG14 | 670/63 |
| TL11-05 DAS 2 | 10/DAS 1105 | 90/7TGG14 | 615/65 |
| TL11-05 DAS 2.1 | 7.5/DAS 1105 | 92.5/7TGG13 | 1150/64 |

The starch adhesives were the main components when adhesive mixtures for gluing of chipboards and wood veneers were produced.

### EXAMPLE 3

### Production of Starch Adhesive

### Adhesives which Comprise Protein

Protein bearing adhesives were produced by adding whey protein or modified whey protein (Uniq Bioresearch Oy) into adhesive which comprises hydroxypropyl starch. The protein amounts varied between 5-50% of the dry matter.

Table 4 shows the compositions and the viscosities of the adhesives. Modified whey protein clearly increased the viscosity of the adhesive less than native whey protein. The proteins did not dissolve in starch adhesive.

TABLE 4
Compositions and viscosities of protein adhesives

| | Starch | | Whey | Viscosity |
|---|---|---|---|---|
| Adhesive | polyol, % | HPS, % | protein, % | cP/Cap % |
| Adhesive 1 | 85.5 | 9.5 | 5 | 4 600/61.5 |
| Adhesive 2 | 81.1 | 8.9 | 10 | 11 400/61.5 |
| Adhesive 3 | 72.0 | 8.0 | 20 | 12 500/61.5 |
| Adhesive 4 | 44.8 | 5.2 | 50 | Not measured |
| Adhesive 5 | 85.5 | 9.5 | 5 | 3000/61.5 |
| Adhesive 6 | 81.1 | 8.9 | 10 | 3 800/61.5 |
| Adhesive 7 | 72.0 | 8.0 | 20 | 10 600/61.5 |
| Adhesive 8 | 44.8 | 5.2 | 50 | Not measured |

HPS: Hydroxypropyl starch from amylose-rich corn starch
Adhesives 1-4: Comprise whey protein
Adhesives 5-8: Comprise modified whey protein

### EXAMPLE 4

### Development of a Transglycosylation Product for Starch Adhesive

It is possible to use the conditions of the transglycosylation reaction and the quality of the reagents to affect the properties, particularly the viscosity of an adhesive product. Table 5 shows the reaction conditions of transglycosylation and Table 6 shows the viscosities of selected products.

TABLE 5
Production conditions of adhesive components which are based on transglycosylation

| | | | | Molar ratio/ | | | |
|---|---|---|---|---|---|---|---|
| | Starch | GLYC | EG | weight ratio | | Addition | Reaction |
| Code | moles | moles | moles | AGU:polyols | Catalyst | of polyols | conditions |
| TGGL-8-04 | 6.17 | 3.30 | 1.64 | 1:0.8/1:0.4 | H₂SO₄, 0.5% | As | 120-125° C./5 h |
| | Addition: | | | | with the polyol | mixture | Glycol removed |
| | ½ initially, | | | | mixture | initially. | at low pressure |
| | ½ 60 min | | | | | | |
| TGGL-9-04 | 7.41 | 3.30 | 1.64 | 1:0.7/1:0.3 | H₂SO₄, 0.5% | As | 120-125° C./5 h |
| | Addition: 40% | | | | with the polyol | mixture | Glycol removed |
| | initially, | | | | mixture | initially. | at low pressure |
| | 40% 60 min, | | | | | | |
| | 20% 130 min | | | | | | |
| TGGL-11 | 6.17 | 3.30 | 1.64 | 1:0.8/1:0.4 | H₂SO₄, 0.5% | As | 120-125° C./5 h |
| | Addition: | | | | with the polyol | mixture | Glycol removed |
| | ½ initially, | | | | mixture | initially. | at low pressure |
| | ½ 40 min, | | | | | | |
| | 15% DL20 | | | | | | |
| TGGL-12- | 6.17 | 3.30 | 1.64 | 1:0.8/1:0.4 | H₂SO₄, 0.5% | As | 120-125° C./6 h |
| | Addition: | | | | with the polyol | mixture | Glycol removed |
| | ½ initially, | | | | mixture | initially. | at low pressure |
| | ½ 40 min, | | | | | | |
| | 30% DL20 | | | | | | |
| 7TGG-8 | 125 | 125 | | 1:1/1:0.6 | H₂SO₄, 0.5% | Initially. | 100-120° C./4 h |
| | Addition: initially | | | | with the polyol | | |
| 7TGG-9 | 126.5 | 99.7 | | 1:0.8/1:0.44 | H₂SO₄, 0.5% | Initially. | 100-120° C./4 h |
| | Addition: initially | | | | with the polyol | | |
| 7TGG-10 | 125 | 125 | | 1:1/1:0.60 | H₂SO₄, 0.5% | Initially. | 117° C./6 h |
| | Addition: | | | | with the polyol | | |
| | ½ initially | | | | | | |
| | ½ 60 min | | | | | | |
| 7TGG-13 | 123 | 123 | | 1:1/1:0.57 | H₂SO₄, 0.5% | Initially. | 100-125° C./6 h |
| | Addition: initially | | | | with the polyol | | |
| 7TGG-14 | 123 | 123 | | 1:1/1:0.57 | H₂SO₄, 0.5% | Initially. | 100-120° C./6 h |
| | Addition: initially | | | | with the polyol | | |
| 250TGG-5 | 617 | 617 | | 1:1/1:0.57 | H₂SO₄, 0.5% | Initially. | 100-120° C./8 h |
| | Addition: | | | | with the polyol | | |
| | ⅔ initially, | | | | | | |
| | ⅓ 130 min | | | | | | |

In Table 5, abbreviation “GLYC” means glycerol and abbreviation “EG” ethylene glycol.

TABLE 6
Viscosities of transglycosylation products

| | Dry | Viscosity cP/ |
|---|---|---|
| Code | matter, % | Temperature ° C. |
| 7TGG-8 | 100 | 2800/120 |
| | 80 | 625/25 |
| 250TGG-5 | 100 | 3000/170 |
| 7TGGL-8 | 100 | 13000/120 |
| | 63 | 35/25 |
| 7TGGL-9 | 100 | 28000/120 |
| | 62 | 40/25 |

### EXAMPLE 5

### Testing of Adhesives in Birch Veneer Gluing

The functionality of adhesives was estimated by preparing adhesive formulations from starch adhesive, tannin and additives, which are described together with the gluing results in the tables and pictures below.

The gluing tests were carried out with a so called Humphrey's device (ABES, Automated Bonding Evaluation System). In the gluing tests, the size of the gumming area of the birch veneer was 20 mm×20 mm. The adhesive mixture was applied onto the two veneer surfaces to be glued, between which an ungummed stick was placed before compressing. The applied adhesive quantity was 250 g/m². The situation simulates the gluing of 3-ply plywood. The compression temperature was 150° C. and compression time 4 minutes. After the compression stage, the device draws the sticks, i.e. determines the shear strength of the glue line. In addition, the wood failure values of the glue line were determined.

TABLE 7
Effect of wood powder on the gluing properties of tannin-bearing starch dhesive, when glyoxal is used as crosslinker
TL 11 adhesive crosslinked with glyoxal: Gluing test carried out
with a Humprey's device. Effect of wood powder quantity

| | | | | | | Breaking | Wood | Breaking | Wood | |
|---|---|---|---|---|---|---|---|---|---|---|
| Test | Adhesvie | TL 11 | Bondtite | Glyoxal | Wood | load | failure | load | failure | |
| number | number | 55% | 345 (50%) | 40% | powder | max, N | max, % | aver, N | aver, % | Note |
| 3 | B | 68 g | 25 g | | | 443 | 0 | 395 | 0 | |
| 4 | C | 30 g | 11 g | 4.4 g | | 725 | 5 | 605 | 1 | |
| 36 | P1 | 30 g | 11 g | 4.4 g | 2.0 g | 668 | 0 | 665 | 0 | Open time |
| | | | | | | | | | | 0.5 h |
| 37 | P1 | 30 g | 11 g | 4.4 g | 2.0 g | 765 | 35 | 626 | 14 | 1 h |
| 38 | P1 | 30 g | 11 g | 4.4 g | 2.0 g | 769 | 15 | 670 | 13 | 2 h |
| 39 | P2 | 30 g | 11 g | 4.4 g | 4.0 g | 857 | 25 | 677 | 16 | 0.5 h |
| 40 | P2 | 30 g | 11 g | 4.4 g | 4.0 g | 736 | 30 | 676 | 23 | 1 h |
| 41 | P2 | 30 g | 11 g | 4.4 g | 4.0 g | 841 | 30 | 625 | 19 | 2 h |
| 42 | P3 | 30 g | 11 g | 4.4 g | 6.0 g | 755 | 15 | 672 | 10 | 0.5 h |
| 43 | P3 | 30 g | 11 g | 4.4 g | 6.0 g | 643 | 20 | 527 | 11 | 1 h |
| 44 | P3 | 30 g | 11 g | 4.4 g | 6.0 g | 671 | 5 | 566 | 3 | 2 h |
| 45 | P4 | 30 g | 11 g | 4.4 g | 8.0 g | 636 | 15 | 581 | 8 | 0.5 h |
| 46 | P4 | 30 g | 11 g | 4.4 g | 8.0 g | 602 | 10 | 569 | 5 | 1 h |
| 47 | P4 | 30 g | 11 g | 4.4 g | 8.0 g | 594 | 5 | 566 | 4 | 2 h |

TABLE 8
Effect of additives on the gluing properties of tannin-bearing starch adhesive
TL 11 adhesive: Effect of additives on adhesive which is crosslinked with glyoxal. Gluing test carried out with a Humphrey's device

| | | | | | | | | | Breaking | Wood | Breaking | Wood | |
|---|---|---|---|---|---|---|---|---|---|---|---|---|---|
| Test | Adhesive | TL 11 | Bondtite | Glyoxal | Wood | | | | load | failure | load | failure | |
| number | number | 55% | 345 (50%) | 40% | powder | Vaniliin | APS | H₂O₂ | max, N | max, % | aver, N | aver, % | Note |
| 3 | B | 68 g | 25 g | | | | | | 443 | 0 | 395 | 0 | |
| 4 | C | 30 g | 11 g | 4.4 g | | | | | 725 | 5 | 605 | 1 | |
| 37 | P1 | 30 g | 11 g | 4.4 g | 2.0 g | | | | 765 | 35 | 626 | 14 | Open time |
| | | | | | | | | | | | | | 1 h |
| 40 | P2 | 30 g | 11 g | 4.4 g | 4.0 g | | | | 736 | 30 | 676 | 23 | 1 h |
| 43 | P3 | 30 g | 11 g | 4.4 g | 6.0 g | | | | 643 | 20 | 527 | 11 | 1 h |
| 46 | P4 | 30 g | 11 g | 4.4 g | 8.0 g | | | | 602 | 10 | 569 | 5 | 1 h |
| 6 | D | 30 g | 11 g | 4.4 g | | 0.45 g | | | 690 | 0 | 657 | 0 | |
| 16 | H3 | 30 g | 11 g | 4.4 g | | | 2.2 g | | 816 | 0 | 710 | 0 | |
| 14 | H1 | 30 g | 11 g | 4.4 g | | | 1.1 g | | 662 | 0 | 654 | 0 | |
| 14 | H1 | 30 g | 11 g | 4.4 g | | | 1.1 g | | 797 | 50 | 730 | 38 | Veneer. |
| | | | | | | | | | | | | | ARS |
| | | | | | | | | | | | | | treatm. |
| 23 | L1 | 30 g | 11 g | 4.4 g | | | | 3% | 510 | 0 | 415 | 0 | |
| 24 | L2 | 30 g | 11 g | 4.4 g | | | | 1% | 518 | 0 | 390 | 0 | |
| 19 | K1 | 30 g | 10 g | 4.0 g | | | | 1.7% | 595 | 0 | 556 | 0 | |
| | | | | | | | | in adhesive | | | | | |

| | | | | | | |
|---|---|---|---|---|---|---|
| 35 | O | Commercial adhesive | 985 | 100 | 875 | 85 |

TABLE 9
Effect of the quality of crosslinking chemicals on the gluing properties of tannin-bearing starch adhesives
TL 11 adhesive: Effect of crosslinking chemicals. Gluing tests carried out with a Humphrey's device

| | | | | | | | | | Breaking | Wood | Breaking | Wood | |
|---|---|---|---|---|---|---|---|---|---|---|---|---|---|
| Test | Adhesive | TL 11 | Bondtite | Glyoxal | ParaHCHO | Cymel 327 | En- | Wood | load | failure | load | failure | |
| number | number | 55% | 345 (50%) | 40% | 100% | 100% | zyme | powder | max, N | max, % | aver, N | aver, % | Note |
| 3 | B | 68 g | 25 g | | | | | | 443 | 0 | 395 | 0 | |
| 4 | C | 30 g | 11 g | 4.4 g | | | | | 725 | 5 | 605 | 1 | |
| 1 | A | 136 g | 50 g | | 2 g | | | | 858 | 10 | 841 | 5 | |
| 40 | P2 | 30 g | 11 g | 4.4 g | | | | 4.0 g | 736 | 30 | 676 | 23 | Open |
| | | | | | | | | | | | | | time |
| | | | | | | | | | | | | | 1 h |
| 49 | A2 | 30 g | 11 g | | 0.5 g | | | 4.0 g | 633 | 100 | 568 | 55 | 1 h |
| 54 | A3 | 30 g | 11 g | | | 1.8 g | | 4.0 g | 1125 | 100 | 966 | 44 | 1 h |

| | | | | | | |
|---|---|---|---|---|---|---|
| 35 | O | Commercial adhesive | 985 | 100 | 875 | 85 |

FIG. 1 is a graph of the gluing results of the crosslinked tannin-bearing starch adhesives, as a function of the reagent.

Furthermore, table 10 shows how the composition affects the adhesive, especially its gluing properties, and FIG. 2 is the corresponding graph of the results presented with the aid of a bar chart.

TABLE 10
Effect of adhesive compositions on the gluing properties
TL 11 adhesive: Effect of crosslinking chemicals. Gluing tests carried out with a Humphrey's device

| | | | | | | Cymel | | | Breaking | Wood | Breaking | Wood- | |
|---|---|---|---|---|---|---|---|---|---|---|---|---|---|
| Test | Adhesive | TL 11 | TL 3/2 | Bondtite | Glyoxal | 327 | | Wood | load | failure | load | failure | |
| number | number | 55% | 61.9% | 345 (50%) | 40% | 100% | Entxyme | powder | max, N | max, % | aver, N | aver, % | Note |
| 3 | B | 68 g | | 25 g | | | 7 | | 443 | 0 | 395 | 0 | |
| 4 | C | 30 g | | 11 g | 4.4 g | | | | 725 | 5 | 605 | 1 | |
| 40 | P2 | 30 g | | 11 g | 4.4 g | | | 4.0 g | 736 | 30 | 676 | 23 | 1 h |
| 54 | A3 | 30 g | | 11 g | | 1.8 g | | 4.0 g | 1125 | 100 | 966 | 44 | 1 h |
| 51 | N1 | | 27.5 g | 11 g | 4.4 g | | | 4.0 g | 610 | 5 | 561 | 1 | 1 h |
| 53 | N3 | | 27.5 g | 11 g | | 1.8 g | | 4.0 g | 1123 | 100 | 949 | 43 | 1 h |

| | | | | | | |
|---|---|---|---|---|---|---|
| 35 | O | Commercial adhesive | 985 | 100 | 875 | 85 |

Table 11 shows how enzyme treatments affect the properties of the adhesive.

TABLE 11
Effect of enzyme treatments on the adhesive properties, when tannin-bearing starch adhesives are used
TL 11 adhesive: Effect of enzyme treatments. Gluing tests carried out with a Humphrey's device

| | | | | | Cymel | | | | | | Aver. | Wood- | |
|---|---|---|---|---|---|---|---|---|---|---|---|---|---|
| Test | Adhesive | TL 11 | Bondtite | Glyoxal | 327 | En- | | Wood | Max Break. | Wood | Break | fail, | |
| number | number | 55% | 345 (50%) | 40% | 100% | zyme | Vaniliin | powder | load | fail. max | load | aver. | Note |
| 3 | B | 68 g | 11 g | | | | | | 443 | 0 | 395 | 0 | |
| 4 | C | 30 g | 11 g | 4.4 g | | | | | 725 | 5 | 605 | 1 | |
| 40 | P2 | 30 g | 11 g | 4.4 g | | | | 4.0 g | 736 | 30 | 676 | 23 | |
| 6 | D | 30 g | 11 g | 4.4 g | | | 0.45 g | | 690 | 0 | 657 | 0 | |
| 7 | E | 30 g | 11 g | 4.4 g | | 2.0 ml | | | 641 | 0 | 594 | 0 | pH 5.38 −> |
| 9 | E3 | 30 g | 11 g | 4.4 g | | 2.0 ml | | | 585 | 0 | 557 | 0 | Bondtite + |
| | | | | | | | | | | | | | enz 0.5 h |
| 48 | P5 | 30 g | 11 g | 4.4 g | | 2.0 ml | | 4.0 g | 584 | 0 | 519 | 0 | pH 5.38−> |
| | | | | | | | | | | | | | 5.0 |
| 12 | F | 30 g | 11 g | 4.4 g | | 2.0 ml | 0.45 g | | 720 | 0 | 654 | 0 | pH 5.38−> |
| | | | | | | | | | | | | | 5.0 |
| 63 | F2 | 30 g | 11 g | 4.4 g | | 2.0 ml | 0.45 g | 4.0 g | 573 | 0 | 457 | 0 | |
| 64 | F3 | 30 g | 11 g | 4.4 g | | 2.0 ml | 0.45 g | 4.0 g | 557 | 0 | 500 | 0 | Bondtite + |
| | | | | | | | | | | | | | enz. 0.5 h |
| 67 | F2 | 30 g | 11 g | 4.4 g | | 2.0 ml | 0.45 g | 4.0 g | 673 | 5 | 652 | 3 | Veneer treatm |
| | | | | | | | | | | | | | enz. |
| 68 | F2 | 30 g | 11 g | 4.4 g | | 2.0 ml | 0.45 g | 4.0 g | 973 | 30 | 862 | 13 | Veneer treatm |
| | | | | | | | | | | | | | enz. + NHA |
| 69 | F2 | 30 g | 11 g | 4.4 g | | 2.0 ml | 0.45 g | 4.0 g | 1027 | 5 | 885 | 1 | Veneer treatm |
| | | | | | | | | | | | | | enz. + vanil |
| 70 | F2 | 30 g | 11 g | 4.4 g | | 2.0 ml | 0.45 g | 4.0 g | 975 | 15 | 885 | 5 | Veneer treatm |
| | | | | | | | | | | | | | enz. + fer. h |
| 65 | S1 | 30 g | 11 g | | 3.6 g | 2.0 ml | 0.45 g | 4.0 g | 1014 | 20 | 896 | 3 | Bondtite + |
| | | | | | | | | | | | | | enz. 0.5 h |
| 66 | S2 | 30 g | 11 g | | 3.6 g | 2.0 g | 0.45 g | 4.0 g | 1145 | 20 | 928 | 15 | |
| 54 | A3 | 30 g | 11 g | | 1.8 g | | | 4.0 g | 1125 | 100 | 966 | 44 | 1 h |

The gluing tests shown in FIG. 3 are carried out with a Humphrey's device; the bar chart illustrates the effect of enzyme treatment on the gluing results of tannin-bearing starch adhesives.

### EXAMPLE 6

### Testing of Different Adhesive Formulations

The following adhesive formulations were prepared, varying the transglycosylation product and the additives. The compositions of the adhesives were as follows:

Adhesive mixture 0 (conventional phenol adhesive)

| | |
|---|---|
| Prefere 14J002 resin | 31.5 g |
| Water | 13.0 g |
| Hardener Prefere 24J662 | 11.0 g |
| Prefere 14J002 resin | 23.8 g |

Adhesive Mixture A3

| | |
|---|---|
| TL 11 - 104 (66.2%) | 28.1 g |
| Bondtite 345 (50%) | 11.0 g |
| Cymel 327 (100%) | 1.8 g |
| Wood powder | 4.0 g |

Adhesive Mixture A

| | |
|---|---|
| TL 11 - 104 (66.2%) | 28.1 g |
| Bondtite 345 (50%) | 11.0 g |
| Cymel 327 (100%) | 1.8 g |

Adhesive Mixture B

| | |
|---|---|
| TL 3 - 104 (67.4%) | 27.6 g |
| Bondtite 345 (50%) | 11.0 g |
| Cymel 327 (100%) | 1.8 g |
| Wood powder | 4.0 g |

Adhesive Mixture C1

| | |
|---|---|
| 7TGGL 804 (62.5%) | 29.7 g |
| LM 100 ((22.7%) | 8.2 g |
| Bondtite 345 (50%) | 11.0 g |
| Cymel 327 (100%) | 1.8 g |
| Wood powder | 4.0 g |

Adhesive Mixture C2

| | |
|---|---|
| 7TGGL 804 (62.5%) | 29.7 g |
| LM 100 ((22.7%) | 16.4 g |
| Bondtite 345 (50%) | 11.0 g |
| Cymel 327 (100%) | 1.8 g |
| Wood powder | 4.0 g |

Adhesive Mixture D1

| | |
|---|---|
| 7TGGL 904 (62.2%) | 29.9 g |
| LM 100 ((22.7%) | 8.2 g |
| Bondtite 345 (50%) | 11.0 g |
| Cymel 327 (100%) | 1.8 g |
| Wood powder | 4.0 g |

Adhesive Mixture D2

| | |
|---|---|
| 7TGGL 904 (62.2%) | 29.9 g |
| LM 100 ((22.7%) | 16.4 g |
| Bondtite 345 (50%) | 11.0 g |
| Cymel 327 (100%) | 1.8 g |
| Wood powder | 4.0 g |

Adhesive Mixture E1

| | |
|---|---|
| 7TGGL 1004 (61.7%) | 30.1 g |
| LM 100 ((22.7%) | 8.2 g |
| Bondtite 345 (50%) | 11.0 g |
| Cymel 327 (100%) | 1.8 g |
| Wood powder | 4.0 g |

Adhesive Mixture E2

| | |
|---|---|
| 7TGGL 1004 (61.7%) | 30.1 g |
| LM 100 ((22.7%) | 16.4 g |
| Bondtite 345 (50%) | 11.0 g |
| Cymel 327 (100%) | 1.8 g |
| Wood powder | 4.0 g |

Adhesive Mixture F0

| | |
|---|---|
| 7TGGL 1204 (61.2%) | 30.3 g |
| Bondtite 345 (50%) | 11.0 g |
| Cymel 327 (100%) | 1.8 g |
| Wood powder | 4.0 g |

Adhesive Mixture F1

| | |
|---|---|
| 7TGGL 1204 (61.2%) | 30.3 g |
| LM 100 ((22.7%) | 8.2 g |
| Bondtite 345 (50%) | 11.0 g |
| Cymel 327 (100%) | 1.8 g |
| Wood powder | 4.0 g |

Adhesive Mixture F2

| | |
|---|---|
| 7TGGL 1204 (61.2%) | 30.3 g |
| LM 100 ((22.7%) | 16.4 g |
| Bondtite 345 (50%) | 11.0 g |
| Cymel 327 (100%) | 1.8 g |
| Wood powder | 4.0 g |

The gluing properties of the adhesives were tested in a similar way as in example 5. The open time before compression varied between 0.5-2 h.

FIG. 4 shows the gluing test results of those gluing tests where the basic composition of the starch adhesive varied. As the figure shows, the composition affects the gluing result, as does the open time before gluing. Addition of hydroxypropyl starch, LM 100, into the basic adhesive mixture either improved or slightly impaired the gluing result. The effect of LM 100 addition on wood failure values was positive.

Addition of wood powder into the adhesive mixture improved the gluing result, adhesive mixtures A (without wood powder) and A3 (wood powder added).

### EXAMPLE 7

This example comprises a study of how the tannin contained in the basic adhesive mixture affects the strength of the glue line in gluing of veneers, when adhesives comprising oxidised starches are used.

The composition of the starch adhesive is shown in example 2. The formulations used in the gluing were

Starch adhesive 100%

### Bondtite 30%

### Cymel 10%

Wood powder 21.5%
and, correspondingly, without tannin
Starch adhesive 100%

### Cymel 10%

Wood powder 21.5%

The gluing tests were carried out in the same way as in the preceding examples. The results are shown in FIG. 5, which clearly demonstrates that addition of tannin into the adhesive mixture improves the strength results of all the adhesive mixtures. The highest strength results without addition of tannin were achieved with the basic adhesive mixture TL 11 RAISA2. Without addition of tannin the result was 14% less than with addition of tannin.

### EXAMPLE 8

### Effect of the Compression Temperature on the Gluing

The effect of the compression temperature on the hardening of the adhesive and the final strength of the glue line were studied by gluing 3-ply plywood according to example 1. The basic adhesive mixture was according to example 1 and the starch adhesive was TL 11. The reference adhesive was a commercial urea-formaldehyde adhesive.

In the gluing process, the open time was 1 hour and the compression time 4 minutes. The compression temperature varied between 100° C. and 140° C.

The results of the gluing tests are shown in FIG. 6, which shows how the compression temperature affects the gluing results.

As the figure shows, higher compression temperatures improve the gluing result and the strength of the glue line increases. Addition of a crosslinker into the adhesive mixture generates chemical reactions, which both accelerate and increase in quantity as a function of the temperature.

### EXAMPLE 9

### Effect of Whey Protein on the Properties of Starch Adhesive

In this example, addition of whey proteins into a basic adhesive mixture and its effect on the final quality of the glue line were studied. The adhesive mixture was according to example 3 (initially). The gluing tests were carried out in a similar way as in the preceding examples.

Whey proteins are suitable for use together with a starch-based adhesive. Addition of whey proteins into the adhesive mixture improved the strengths of the glue line, in comparison with the gluing tests which were carried out without addition of whey proteins.

When the quantity of either modified or unmodified whey protein in the adhesive mixture was 5-20%, the strengths increased slightly. When the quantity of whey proteins in the adhesive mixture was 50%, the strength increased, by 20% with the unmodified, and by 28% with the modified whey protein, compared with the mixtures which did not comprise any whey protein. The reference adhesive used in the tests was a commercial urea-formaldehyde adhesive. The strengths with the best adhesive mixture that comprised whey protein were 91% of the urea-glued strength.

The following examples describe, among others, production of chipboards and the properties of these boards.

### EXAMPLE 10

### Production of Chipboard

The composition of the basic adhesive mixture was

| | |
|---|---|
| starch adhesive | 100 parts by weight |
| tannin (Bondtite) | 30 parts by weight |
| crosslinking agent (Cymel) | 10 parts by weight |

The composition of the starch adhesive is described in example 1. The reference was a commercial urea-formaldehyde adhesive.

### Material to be Glued

Middle-layer particles, which were predried at the mill, were used in the production of chipboards. The moisture content of the chips was 15%.

### Carrying-Out of the Gluing Tests and Determining the Quality of the Gluing

One-layer chipboard was prepared by using a single-ported laboratory press. The chips were gummed in a gumming machine which functions according to the charge principle. The adhesive was sprayed on the chips by using a high-pressure (25 MPa) paint sprayer. The chips of three boards were gummed in one go. The chips were scattered by hand to form blanks and then compressed in a laboratory press to form chipboards. The adhesive quantity was 20% (adhesive dry matter of chip dry matter), the compression temperature was 180° C. and the compression time was 10 minutes (1 min/mm).

The transverse tensile strength (SFS EN 319) and the thickness swelling and the absorption of water after a period of 2 hours and 24 hours in water soaking, were determined from the test boards. The thickness swelling was determined according to standard (SFS EN 317). The absorption of water was determined with the help of mass measurements of test specimens, which were carried out together with the thickness measurements. The density was determined from all test specimens (SFS EN 323). Boards for parallel tests were prepared with different densities.

The number of parallel test specimens was five per each board. Before the tests were carried out, the test specimens were stabilised at conditions where the temperature T was (20±1° C. and the relative humidity of air RH was (65±5) %.

FIG. 8 shows how the adhesive affects the transverse tensile strength, with starch adhesives TL 11 and TL 14, and with a commercial UF adhesive.

As the figure demonstrates, the transverse tensile strength increased clearly with increasing density with all the studied adhesive types. By using the starch adhesive TL 11, approximately 80% of the transverse tensile strength of the boards, which were glued with urea-formaldehyde adhesives, was achieved, and by using starch adhesive TL 14, 65-70%.

FIG. 9, in turn, shows how the adhesive affects the water absorption during a 24-hour water soaking, with starch adhesives TL 11 and TL 14, and with a commercial UF adhesive.

According to the figure, water absorption during a two-hour water soaking has been lowest for boards which are glued with TL 11. For Bakelite UF-glued boards, water absorption has been slightly more at lower densities, but the difference is emphasised with increasing density, during a two-hour water soaking. In a 24-hour soaking at low densities (under 680 kg/m³) the water absorption of Bakelite UF has been lowest, but at higher densities the TL 11-glued boards have absorbed less water.

FIG. 10 shows the effect of adhesive on the thickness swelling in a 24-hour water soaking, with starch adhesives TL 11 and TL 14, and with Bakelite UF.

Thickness swelling in a two-hour water soaking increases with increasing density, for urea-formaldehyde glued boards, whereas the thickness swelling decreases with increasing density, for starch glued boards. In a 24-hour soaking, at low densities (under 720 kg/m³), the swelling of a urea-formaldehyde glued board has been least, but at higher board densities, TL 11 glued boards have swollen less and the swelling decreases further with increasing density.

### EXAMPLE 11

### Pretreatment of the Wood Surface

The effects of chemical and enzymatic pretreatments of the wood surface on the wood surface and the gluing were studied using birch veneers. Onto the surface of the veneers, 0.1 ml of laccase enzyme was added and applied on a sample area of 2 cm×3 cm. The enzyme dose was always 20-500 nkat/veneer, depending on the test. The enzyme was allowed to take effect for a desired period of time (generally 30 min). After that, 0.1 ml of an additive solution was added onto the surface of the veneer, said solution was also applied on a marked area on the surface of the veneer. The additive was allowed to take effect for a desired period of time (generally 30 min). During the treatments, the samples were at a desired temperature, generally room temperature. After that, the hydrophobicity was determined from the dry veneers by measuring the time elapsed for a drop to be absorbed. In the gluing tests of the veneers, the veneers were pretreated on both sides of the glue line. The gluing was carried out according to example 1, with a basic adhesive mixture and the strength of the glue line was determined according to example 1.

Table 11 comprises the materials used in the pretreatments, the hydrophobicity determined as the absorption time of a drop of water, and the strength results of the glue line.

TABLE 11
Effects of pretreatments of birch veneer on the hydrophobicity
of the veneer surface and on the strength of the glue line

| | Enzyme | Percentage | Absorption | Change in | Wood |
|---|---|---|---|---|---|
| | dose | of additive | time of a drop | breaking | failure |
| Treatment | (nkat/cm²) | (g/l) | of water (min) | load (%) | (%) |
| untreated | — | — | 0 | 0 | 0-18 |
| laccase | 33.3 | — | 0-0.67 | 26 | 37.5 |
| dodecyl gallate | — | 8.12 | 0 | — | — |
| (DOGA) | | | | | |
| laccase + DOGA | 8.3 | 8.12 | 35 | — | — |
| laccase + vanilin | 83.3 | 5 | 0.34 | — | — |
| laccase + lignine of | 83.3 | 8 | 0 | −4 | 9 |
| birch (LGF4.5) | | | | | |
| laccse + lignine of | 33.3 | 8 | 0.45 | −1 | 12.5 |
| spruce (LGF7) | | | | | |
| sodium citrate | — | 50 mmol/l | 0 | −2 | 26 |
| sodium succinate | — | 50 mmol/l | 0 | −5 | 15 |

LGF4.5, LGF7 are nanoparticles of organosolv-lignine (FI20075823)

Pretreatment of birch veneer with laccase and hydrophobic dodecyl gallate clearly slowed down the absorption of the water drop and thereby increased the hydrophobicity of the veneer surface. Also, treatment with laccase or with laccase and lignine of spruce, slightly increased the hydrophobicity of the veneer surface.

It was possible to increase the breaking load and the wood failure with laccase treatment, as well as with citrate treatment and succinate treatment.

### EXAMPLE 12

### Production of Chipboard from Pretreated Chip

Chipboard was produced according to example 5. An addition to example 5 was pretreatment of chips before gumming. In the pretreatment of chips, the effect of either laccase or dodecyl gallate (DOGA) or their combined effects on the properties of the board, were studied.

In the first alternative, the pretreatments were carried out as follows a) hydrophobic dodecyl gallate or laccase was added to the chips, after which they were allowed to take effect for a period of 30 minutes, after which the chips were dried, and b) the dried chips were gummed and compressed into chipboards. When the combined effects were studied, the laccase was blended with the chips by mixing them in the gumming machine for a period of half an hour before addition of dodecyl gallate. The time of effect of DOGA was 30 minutes, too, before the gumming of the chips and production of the board.

FIG. 11 shows how pretreatment of chips affects the transverse tensile strength: Laccase=200 nkat/g (30 min); DOGA=water, quantity corresponds to the laccase volume+Doga (30+30 min).

Pretreatments of chips carried out with dodecyl gallate or laccase increased the transverse tensile strength of the board, at lower densities, as shown in FIG. 11. The combined effects (TL 11E) of laccase and DOGA had a bigger effect on the water absorption and the thickness swelling of the board. Due to the treatments, the properties of the boards were improved, see FIGS. 12 and 13.

### EXAMPLE 13

### Effect of Crosslinkers on the Gluing Properties

In the example, a comparison was carried out between different chemicals which were suitable for crosslinking of starch adhesive. The gluing tests were carried out with a Humphrey's device, according to example 1. Also, the basic adhesive mixture was according to example 7, with the exception that Cymel, which was used as crosslinking agent, was replaced with the following chemicals: citric acid, polypropylene diglycidyl ether, HDGE and ammonium zirconium carbonate.

The best gluing results were achieved with ammonium zirconium carbonate (AZC). The strength of the glue line was 93% of the strength which was achieved with Cymel.

### EXAMPLE 14

### Production of Chipboard by Using AZC as a Crosslinking Agent in the Basic Adhesive Mixture

The gluing tests were carried out according to example 10. Also, the basic adhesive mixture was according to example 10, with the exception that Cymel was replaced with ammonium zirconium carbonate. The transverse tensile strength and the formaldehyde quantity which was released from the board, were determined from the final boards. The formaldehyde percentage was determined according to standard EN120.

FIG. 14 shows the strength results when different crosslinkers are used. Formaldehyde percentages were determined from middle-layer particle boards which were prepared in the laboratory, and from the chip raw material, in which case FIG. 15 reveals that from the board which comprises adhesive TL 11 Cymel, substantially more formaldehyde was released than for example from corresponding starch adhesive-bearing boards. When inorganic crosslinkers were used, the levels were 0.10-0.12%, whereas the value of the untreated chip used in the production of boards was 0.89%.

1. An adhesive composition which comprises an adhesive component that is dissolved or dispersed in water, where-in the adhesive component comprises polyphenol and a starch derivative, the weight ratio between the polyphenol and the starch derivative being between 1:50 to 50:1, and the dry matter percentage of the adhesive composition being at least 40% by weight.

2. An adhesive composition according to claim 1, wherein its viscosity makes it so fluid that it can be sprayed.

3. An adhesive composition according to claim 1, wherein it comprises, as polyphenol tannin, lignine or flavonoid or a mixture thereof, or derivatives of these compounds or a mixture thereof.

4. An adhesive composition according to claim 1, wherein it comprises, as starch derivative, a transglycosylation product of native starch, the degree of polymerisation of which product is higher than DP 7, and which comprises an alkyl or hydroxyalkyl glycoside, the alkyl or hydroxyalkyl groups of which comprise a carbon chain which includes 1-4 carbon atoms, which chain has 0-3 free hydroxyl groups and is attached to the 1-carbon of the anhydroglucose unit via the oxy group.

5. An adhesive composition according to claim 1, wherein the molecular weight of the transglycosylation product of the native starch is 1,200-50,000.

6. An adhesive composition according to claim 1, wherein it comprises additives, calculated from the total weight of the composition, 0.01-30% by weight of inorganic chemicals, polyflinctional compounds, dialdehydes, diepoxides, urea, urea derivatives or multiflinctional carboxylic acids and, as additives and regulatory materials, water soluble ethylene glycol esters, ethylene glycol ethers, glycerol esters, CMC or other water soluble cellulose derivatives or water soluble hydroxypropyl starch or oxidised starch and/or proteins.

7. An adhesive composition according to claim 1, wherein it comprises, as crosslinker, an aldehyde compound, dialdehyde compound, melamine resin or inorganic salt, or a mixture of two or more crosslinkers.

8. An adhesive composition according to claim 1, wherein it comprises between 5-75 parts by weight of polyphenole per 100 parts by weight of the starch derivative.

9. An adhesive composition according to claim 1, wherein it comprises, as an adhesive component, 0.1-50 parts by weight of protein per 100 parts by weight of the starch derivative.

10. An adhesive composition according to claim 1, wherein its viscosity is between 1,000-50,000 cP at 120° C.

11. An adhesive composition according to claim 1, wherein its solids percentage is 10-100% by weight.

12. An adhesive composition according to claim 1, wherein all of its adhesive components are sourced from renewable raw materials

13. A method of producing an adhesive composition comprising the steps of dissolving or dispersing a first adhesive component which comprises polyphenol and a second adhesive component which comprises a starch derivative in water, wherein the polyphenol and the starch derivative are added into water at a weight ratio of between 1:50 to 50:1 wherein the added quantities of the polyphenol and the starch derivative are such that the dry matter percentage of the adhesive composition is at least 40% by weight.

14. (canceled)

15. (canceled)
